(19) United States
(12) Patent Application Publication
(10) Pub. No.: US 2004/0195533 A1
(43) Pub. Date: Oct. 7, 2004

(54) Membrane valve

(76) Inventors: Valentin Mall, Gundelsheim (DE); Martin Hiller, Bad Rappenau (DE)

Correspondence Address: Welsh & Katz, 22nd Floor, 120 South Riverside Plaza, Chicago, IL, 60606, US

(21) Appl. No.: 10/486,961

(22) PCT Filed: Jun. 12, 2002
(86) PCT No.: PCT/EP02/06474

(30) Foreign Application Priority Data
Aug. 14, 2001 (DE) 101 39 815.8

(51) Int. Cl. F16K 31/143

(52) U.S. Cl. 251/63.5; 251/331

(57) ABSTRACT

The invention relates to a membrane valve, for transfer of biological and pharmaceutical products in particular, which an be opened pneumatically. By introducing air through an inlet opening (19) said air therein through a hollow spindle (4, 13, 23) reaches the space below a piston (12), lifts the latter and thus opens said valve. By providing for a hollow spindle (4, 13, 23) the supply of air can be effected in the drive portion. Interfering conducts and devices outside of said valve can thus be avoided, this permitting a more compact, room-saving construction of said valve as well as a simplified maintenance and cleaning of said valve.

The invention pertains to a membrane valve, for use in the transfer of liquid and gaseous media in pharmaceutical industry and biotechnology in particular.

High demands are set in drafting conception and using conduct fittings like conducts, valves and the like in the filed of pharmaceutical industry and biotechnology in particular in view of cleanness of fittings. Particularly, the matters with which the medium fed through a conduct system comes into contact, are not to contribute to pollution thereof. This results in special requirements with respect to quality of valves used, membrane valves in particular. Thus, the valves must permit simple and efficient cleaning. Mostly, for these reasons the conduct system or individual product conducts, respectively, are regularly sterilized using highest grade vapor, partly the complete system is supplied to autoclaving for cleaning. Such cleaning carried out regularly is subject to high expense. I.e. the systems must be of such condition that no parts disturbing cleaning are present, this often not being permitted by the complex construction of fittings.

A further problems in this connection lies in that due to the complex construction of valves in particular, maintenance is difficult, since product conducts in most cases can be separated from the remaining components (drives for the valves, controlling air supply, hose and cable connections positioned outside laterally and the like) only with difficulties. Moreover, known valves due to these components have a comparatively large spatial expansion so that their installation is connected with substantial space requirements.

It, therefore, is the object of the present invention to create a membrane valve permitting simple maintenance and cleaning and in addition not including the above-mentioned disadvantages.

In accordance with the present invention this object is solved by a membrane valve with a valve body for transfer of a flowing medium and a drive portion for controlling said valve. The valve body comprises first and second chambers separable by the membrane, said drive portion being separated into a piston chamber and a lower drive part separated therefrom. The drive portion comprises a spindle connected to an inner pressure piece on one end, said pressure piece being connected to a membrane for opening and closing the valve. Furthermore, said drive portion includes a first spindle top connected to the other end of the spindle, and a piston held by the spindle and/or the spindle top and integrally movable with said spindle. Moreover, in the drive portion at least on return spring is provided for by which the piston is pretensioned such that the pressure piece presses against the membrane via piston and spindle and thereby the first and second chambers are separated from one another and the valve is in a closed condition. In addition, in the drive portion an inlet opening for introduction of air for the pneumatic lifting of the piston against the tensioning direction of the spring is provided for. Herein, the spindle and the spindle top include a hollow which on one end is in flowing connection with the inlet opening and on the other end is in flowing connection with the area below the piston.

By this valve construction control air supply for lifting the piston can be effected through said hollow spindle. The control air exists the spindle below the drive piston and thus presses the piston upwardly. Hereby it is rendered possible that the control air supply is embodied far away from the product conduct so that the corresponding connections for the control air can be mounted very comfortably and can be removed for maintenance or cleaning, this permitting simple handling of the valve. In addition the control air reaches the space below the piston via the interior of the valve so that no external supply conducts are required so that in total the outer structure of the valve is simplified and space requirement is reduced. Moreover, cleaning of the valve is facilitated by the simplification of construction.

The inlet opening for connecting the control air can be provided for laterally on the upper section of the drive portion so that the long axis of the inlet opening extends in perpendicular to the long axis of the spindle. With this construction in flowing connection between the inlet opening and the hollow preferably expansion bellows are provided for which balances the movement of the spindle so that the air supply to the spindle is embodied flexibly and goes along with lifting and lowering of the piston.

Alternatively, air supply to the membrane valve can also be effected directly from bottom centrally or excentrically. For this purpose, in accordance with a preferred embodiment of the invention it is provided for that the long axis of the inlet opening is in parallel with the long axis of the spindle. Hereby connection of control air is highly simplified, this being particularly suitable for switching of several valves in accordance with the present invention, in form of series construction.

For this purpose a pilot valve can be provided for in the membrane valve in accordance with a preferred embodiment. The pilot valve, preferably a solenoid valve is provided for supplying air on the drive portion in flowing connection with the inlet opening. It controls opening and closing of the membrane valve and is controlled using control electronics or the like. By integration of a pilot valve the requirement of cleanness, indifference to pollution, purificability and compactness is met in high degree.

The membrane valve in accordance with a preferred embodiment in the drive portion comprises first and second outlet openings for escape of air from the piston chamber and the lower drive part. Hereby pressure created in the interior of the valve by moving the piston and the pressure piece can be carried away.

In accordance with a further embodiment of the invention a position indicator showing the opening condition of the valve is provided for on the membrane valve so that the condition of the valve can always be recognized from the outside.

A further advantage in this membrane valve results in the construction of system components in which the pilot valve is integrated. Those e.g. are electrical/optical position indicator, ASI bus mountings etc.

In this case control air supply into the system component is effected through the pilot valve into the drive. The drive cover in this case is provided with an annular groove guiding the air into the hollow spindle through a cross bore using the most various possibilities indicated. The advantage lies in that therefor no external conducts and connections are required.

Due to the displacement of air supply also essential advantages result with respect to access to the product conduct. This in an exchange does not depend on the condition in the medium membrane which in this application often is subject to a cyclic exchange. Moreover, also an essential advantage results as soon as the product conduct has to be isolated.

Depending on the transfer medium usually pipeline systems, fittings and the like are operated with different operating pressures. For guaranteeing sealing of the fittings it may occur that during the change to another transfer medium the fittings have to be exchanged. To avoid this the membrane valve in accordance with the present invention in a further preferred further development is provided with several springs each with different tension force respectively adapted to different operating pressures of the valve. Hereby, the valve in accordance with the present invention can be used in an existing pipeline system without exchange or reconstruction and in addition without adaptation permits the use with different operating pressures so that is allows a plurality of applications.

The invention and its preferred embodiments now will be schematically explained in more detail with reference to the attached drawing. In the drawing

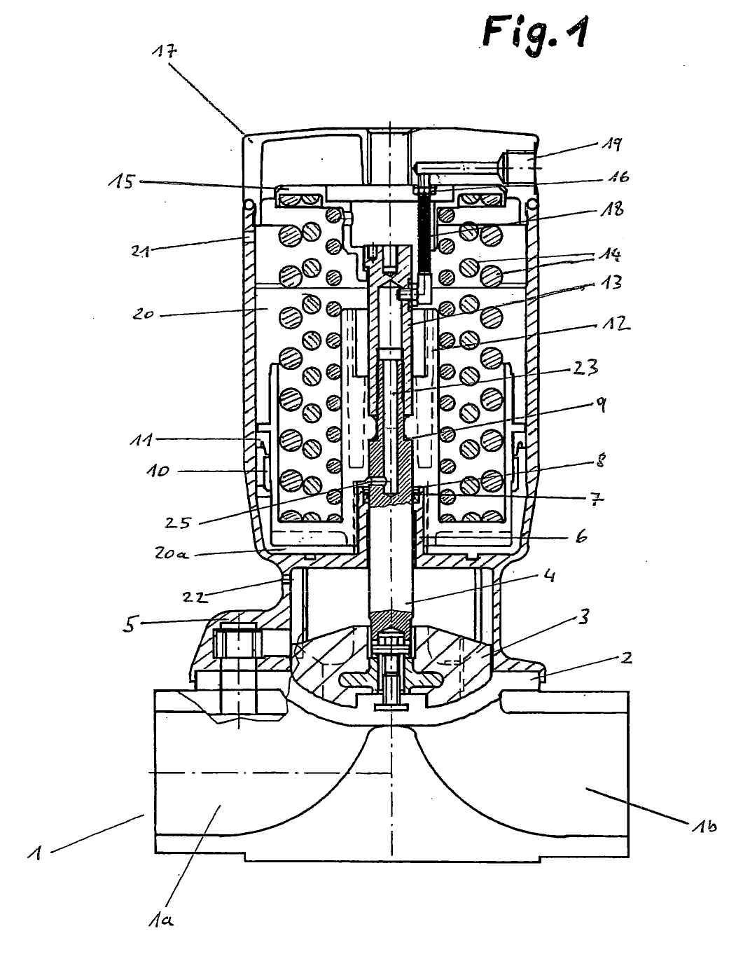

FIG. 1 shows a first embodiment of the present invention in cross-sectional view, and

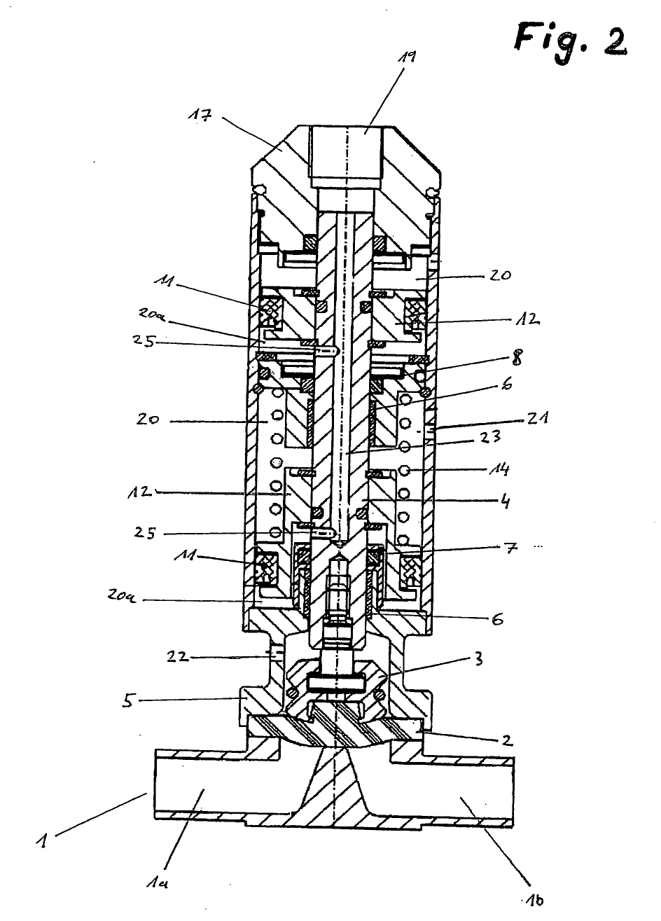

FIG. 2 shows a second embodiment of the present invention in cross-sectional view.

In FIG. 1 a first embodiment of the invention is shown in cross-sectional view. In the lower portion there is a valve body 1 comprising a first chamber 1a and a second chamber 1b, through which the transfer medium is guided. The path from said first chamber 1a to said second chamber 1b can be closed by a membrane 2 which can consist of an elastomer, PTE or the like (shown in the drawing in closed condition).

On the side of the membrane 2 not facing said valve body 1 a pressure piece 3 is mounted which can consist of special steel or synthetic material. Said pressure piece 3 is located in a pressure piece chamber 24 separated from a piston chamber 20, 20a located thereabove so that no air exchange is possible between pressure piece chamber 24 and piston chamber 20, 20a. Said pressure piece 3 again is connected to the lower end of a spindle 4 which preferably consists of special steel. Said spindle is movably supported in a slide sleeve 6 which can consist of different materials with additional slide coatings like PTFE/coal. Thus, said pressure piece 3 can be reciprocated using said spindle 4 in up- and downward directions, whereby said membrane 2 is lifted and lowered and said membrane valve is opened and closed. For escape of air an outlet opening is provided for in the wall of said pressure piece chamber 24.

Said spindle 4 on the upper end in said piston chamber 20, 20a is connected to a spindle top 13 of special steel or the like, preferably by screwing. In the area of this connection of spindle 4 and spindle top 13 a piston 12 is mounted so that it can be integrally moved with said spindle 4. Said piston 12 bears on a lock washer 8 of special steel or the like, connected to said spindle 4, and a sealing ring 7 located therebelow, of synthetic material (NBR). In the connecting area between spindle 4 and spindle top 13 an O-shaped rings of synthetic material is provided for sealing so that no air can escape through the inner area of said piston 13 into said pressure piece chamber 24. On its outside said piston 12 is provided with a retaining ring 10 of synthetic material (PP) and a piston groove ring of NBR or the like so that no air exchange can occur between piston chamber 20 and the area below said piston 20a. Said piston 12 is pretensioned using at least one spring 14 against a intercepting plate 15 serving as abutment so that said piston together with said spindle 4 and the pressure piece is pressed downwardly so that said membrane 2 closes the transfer path between first and second chambers 1a, 1b.

In said spindle 4 and in said spindle top 13 a hollow 23 is formed. On the upper end of said hollow there is an opening through which control air can come into said hollow 23 from the outside through an inlet opening 19. On the lower end of said hollow 3 an outlet opening 25 is provided for through which said control air reaches the space below said piston 20a so that said piston 12 can be lifted against said pretension of said spring 14 by letting in air through said inlet opening 19. Said inlet opening 19 can be provided with a thread for screwing a connecting piece for the pressure air conduct. A flexible connection 16 (e.g. expansion bellows 18 or the like) balancing the reciprocating movement of said spindle 4 and said spindle top 15 and creating a flexible flow connection 16 between inlet opening 19 and hollow 23 is provided for between said inlet opening 19 and said hollow 23. (A flexible connection is not required provided that said drive chamber in the area of entry of air of said inlet opening 19 and said hollow spindle 4, 13 is sealed such that the incoming air can only escape into said hollow 23 of said hollow spindle 4, 13.)

In the area of said flexible flow connection additionally also a pilot valve (not shown) can be integrated into the air path. Therein, it is a matter of a solenoid valve preferably, which controls opening/closing of said membrane valve using control electronics or the like, by letting pass pressure air applied to said inlet opening 19 or correspondingly blocking it. An integration of a pilot valve permits a particularly compact construction of the valve in accordance with the present invention. The same is true for the construction of system components with pilot valve, since in these cases the supply line disposed externally can be done without.

The operation of said membrane valve now is effected as follows. When compressed air is introduced into said inlet opening 19, it reaches said hollow 23 of spindle 4 and spindle top 3 through said expansion bellows 18. On the lower end of said hollow 23 said compressed air exists into the space below said piston 20a through said opening 25 (there also may be provided several openings 25). The air collecting in said chamber 20a presses said piston 12 against the tension of said spring 14 upwardly. Hereby spindle 4, spindle top 13, pressure piece 3 and membrane 2 are lifted and said expansion bellows 18 are compressed. Said membrane valve opens and the transfer good can be transferred in said valve body 1 from said first chamber 1a into said second chamber. When said compressed air is switched off, the air collected in the chamber below said piston 20a escapes through said hollow 23 and said piston 12 together with said piston 4, said spindle top 13, said pressure piece 3 and said membrane 2 is pressed in downward direction by said spring 14, said expansion bellows relaxes and said valve closes.

A further embodiment of the invention is shown in cross-sectional view in FIG. 2 in the example of a double piston valve. The reference numerals in FIG. 2 denominate the same components and devices as in FIG. 1. Here, said inlet opening 19 for said compressed air is not located laterally on said drive portion but is coaxially formed with the long axis of said hollow spindle 4 in said drive cover 17. Hereby a balancing mechanism in form of a flexible part 16 can be done without, since the air can be guided into said hollow 23 of said spindle 4 directly. Said inlet opening preferably is provided with a thread onto which a coupling for a supply conduct (not shown) can be screwed. Here, too, like in the example of FIG. 1 a pilot valve can be provided for either flanged externally or in said drive portion between inlet opening 19 and spindle opening.

Also said membrane valve shown in FIG. 2 due to the compact construction of the valve in accordance with the present invention is optimally suitable for arrangement in parallel or in series. The compact construction can only be achieved by said double piston, since the required spring forces demand for a too high control pressure by one simple piston. Also the automation of system components is possible using a pilot valve with function control and/or selection. In addition to all that, only on top of said valves or on said system component conduct connections have to be mounted, other conducts on said valves can be saved due to the air path in accordance with the present invention, through said hollow spindle 4. This on one hand facilitates access of valves in accordance with the present invention in case of maintenance, on the other hand said valves are indifferent to pollution, are easily to clean (self-cleaning) and thus offer optimum provisions for improved processes in their use.

### List of Reference Numerals

1. valve body

1a. first chamber

1b. second chamber

2. membrane

3. pressure piece

4. spindle

5. lower drive part

6. slide sleeve

7. sealing ring

8. lock washer

9. O-shaped sealing ring

10. retaining ring

11. piston groove ring

12. piston

13. spindle top

14. spring

15. intercepting plate

16. flexible connection

17. drive cover

18. expansion bellows

19. inlet opening

20. piston chamber

20a. chamber below the piston

21. first outlet opening

22. second outlet opening

23. spindle hollow

24. pressure piece chamber

25. exit opening

1. membrane valve with a valve body (1) for transferring a flowing medium and a drive portion (5, 17) for controlling said valve, wherein said valve body (1) comprises first and second chambers (1a, 1b) separable by said membrane, and wherein said drive portion (5, 17) is subdivided into a piston chamber (20) and a lower drive part (5) separated therefrom and comprises:
a spindle (4) connected to a pressure piece (3) on one end, wherein said pressure piece (3) is connected to a membrane (2) for opening and closing said valve, a spindle top (13) connected to the other end of said spindle (4),
a piston (12) held by said spindle (3) or/and said spindle top (13) and integrally movable with said spindle (4),
at least one return spring (14) by which said piston (12) is pretensioned such that said pressure piece (3) via piston (12) and spindle (4) presses against said membrane (2) and thereby said first and second chambers (1a, 1b) are separated from one another and said valve is in a closed condition,
an inlet opening (19) for introducing air for the pneumatic lifting of said piston (12) against said tensioning direction of said spring (14),
wherein said spindle 94) and said spindle top 913) comprise a hollow on one end being in flowing connection with said inlet opening (19) and on the other end being in flowing connection with the space area below said piston (20a).

2. Membrane valve as defined in claim 1, characterized in that the long axis of said inlet opening (19) extends perpendicularly to the long axis of said spindle (4).

3. Membrane valve a defined in claim 2, characterized in that the flowing connection between said inlet opening (19) and said hollow comprises expansion bellows.

4. Membrane valve as defined in claim 1, characterized in that said long axis of said inlet opening (19) extends in parallel to said long axis of said spindle (4).

5. Membrane valve as defined in claim 1, characterized in that for supplying air a pilot valve is provided for on said drive portion (17) in flowing connection with said inlet opening (19).

6. Membrane valve as defined in claim 6, characterized in that said pilot valve is a solenoid valve.

7. Membrane valve as defined in claim 1, characterized in that in said drive portion (5, 17) first and second outlet openings (21, 22) for escape of air from said piston chamber (20) and said lower drive part (5) are provide 4 for.

8. Membrane valve as defined in claim 1, characterized in that it comprises a position indicator indicating the opening condition of said valve.

9. Membrane valve defined in claim 1, characterized in that several springs (14) with correspondingly different tension force are provided for which are correspondingly adapted to different operating pressures of said valve.
